(19) United States
(12) Patent Application Publication
(10) Pub. No.: US 2015/0351125 A1
(43) Pub. Date: Dec. 3, 2015

(54) APPARATUS AND METHOD FOR ALLOCATING RESOURCE

(71) Applicant: Electronics and Telecommunications Research Institute, Daejeon (KR)

(72) Inventors: Hyoung Jin KWON, Daejeon (KR); Jae Seung LEE, Daejeon (KR); Min Ho CHEONG, Daejeon (KR); Hee Jung YU, Daejeon (KR); Jae Woo PARK, Daejeon (KR); Sok Kyu LEE, Daejeon (KR)

(21) Appl. No.: 14/412,656

(22) PCT Filed: Jul. 2, 2013
(86) PCT No.: PCT/KR2013/005851

§ 371 Date: Jan. 2, 2015

(30) Foreign Application Priority Data
Jul. 2, 2012 (KR) 10-2012-0071642
Jul. 2, 2013 (KR) 10-2013-0076914

(51) Int. Cl. H04W 74/00

(52) U.S. Cl. CPC H04W 74/002; H04W 84/12

(57) ABSTRACT

Provided is an apparatus and method for allocating a resource. According to an embodiment of the present invention, the method of allocating a resource in which an access point allocates a resource for communication between a first station and a second station based on a slot-based channel access scheme in a wireless local area network, the method including confirming a wakeup schedule set between the first station and the second station, and allocating the resource for communication between the first station and the second station through the slot-based channel access scheme reflecting the confirmed WS.

### TECHNICAL FIELD

Exemplary embodiments relate to an apparatus and method for allocating a resource that an access point managing a network in a wireless local area network (WLAN) environment may allocate a resource for communication between stations based on a slot-based channel access scheme, and a terminal operating thereby.

### BACKGROUND ART

In an infrastructure mode of a wireless local area network (WLAN), data being transmitted and received between terminals is transferred through an access point (AP). In the Institute of Electrical and Electronics Engineers (IEEE) 802.11e, direct link setup (DLS) specifies direct transmission and reception of data between Quality of Service (QoS) stations (STAs) to increase channel use efficiency to double or more. Similar to 802.11a/b/g, 802.11z also supports a method of enabling DLS (Tunneled DLS) and a power saving mode (PSM) even in an environment in which an AP is a non-QoS AP. A pair of QoS APs supporting (T)DLS exchange data without AP intervention.

However, in an environment in which in an extremely large number of STAs exist in a network or there is a high probability of collision between STAs due to a hidden node, one of solutions for resolving the foregoing issue is allocation based on slot-based channel access that enables an AP to divide a channel access time into slots having a predetermined length and allocate, to a slot, a point in time at which STAs access a channel.

However, with respect to a point in time at which STAs supporting (T)DLS will exchange data directly, other STA including an AP is not aware of the point in time. Particularly, when STAs operate in a TDLS Peer PSM, the STAs sleep periodically in accordance with a schedule and wakes up at particular interval to attempt to exchange data, however an AP is not aware of the periodic schedule, and thus, there is a possibility of overlapping schedules with slot-based resource allocation of the AP.

### DISCLOSURE OF INVENTION

### Technical Solutions

According to an aspect of the present invention, there is provided a method of allocating a resource in which an access point allocates a resource for communication between a first station and a second station based on a slot-based channel access scheme in a wireless local area network, the method including confirming a wakeup schedule (WS) set between the first station and the second station, and allocating the resource for communication between the first station and the second station through the slot-based channel access scheme reflecting the confirmed WS.

According to another aspect of the present invention, there is provided a resource allocation apparatus for allocating a resource for communication between a first station and a second station based on a slot-based channel access scheme in a wireless local area network, the apparatus including a processing unit to confirm a WS set between the first station and the second station, and an allocation unit to allocate the resource for communication between the first station and the second station through the slot-based channel access scheme reflecting the confirmed WS.

### Effects of the Invention

When an access point (AP) sets up a schedule for resource allocation for communication or periodic resource allocation in a wireless local area network (WLAN), the AP performs setting together with tunneled direct link setup (TDLS) stations (STAs), thereby avoiding overlapping schedules with other preset schedule.

Also, power consumption caused by collision may be reduced by notifying other station within a network of the scheduled resource allocation for communication between the stations to limit their access.

Also, power consumption may be reduced by reducing a probability of collision caused by a hidden node problem with TDLS STAs exchanging data directly using a resource allocated in accordance with a schedule that are hidden from other station in a network.

### BRIEF DESCRIPTION OF DRAWINGS

FIG. 1 is a diagram illustrating a wireless local area network (WLAN) environment including an access point (AP) and a plurality of terminals, to which an embodiment of the present invention is applicable.

FIG. 2 is a flowchart illustrating a method of allocating a resource in which an AP allocates a resource according to an embodiment of the present invention.

FIGS. 3 and 4 are flowcharts illustrating respective embodiments in which an AP confirms a wakeup schedule (WS) set between a first station and a second station according to an embodiment.

FIGS. 5 and 6 are diagrams illustrating an example of using a sync frame to prevent collision or save power when two stations are hidden nodes in a conventional slot-based channel access scheme.

FIG. 7 is a diagram illustrating a WLAN environment including an AP and a plurality of terminals according to an embodiment.

FIG. 8 is a diagram illustrating a relationship between a station hidden from two stations and the corresponding two stations in a conventional slot-based channel access scheme.

FIG. 9 is a diagram illustrating a configuration of an apparatus for allocating a resource according to an embodiment.

### BEST MODE FOR CARRYING OUT THE INVENTION

Hereinafter, exemplary embodiments of the present invention are described in detail with reference to the accompanying drawings.

In the description of the exemplary embodiments of the present invention, descriptions of well-known functions or components are omitted so as to not unnecessarily obscure the embodiments herein. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein. Hence, the terms must be interpreted based on the contents of the entire specification.

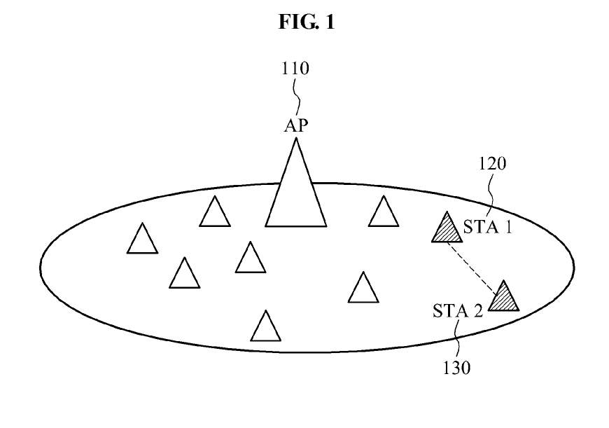

FIG. 1 is a diagram illustrating a wireless local area network (WLAN) environment including an access point (AP) and a plurality of terminals, to which an embodiment of the present invention is applicable.

In a WLAN, a power saving mode (PSM) is defined to reduce power consumption of terminals—STA 1 120 and STA 2 130. An AP 110 transmits a beacon periodically, and transmits a presence or absence of a buffered frame to the terminals—STA 1 120 and STA 2 130—through a traffic indication map (TIM) field of the beacon. The following description will be provided by representing the terminals—STA 1 120 and STA 2 130—as a terminal STA.

The STA in a sleep mode wakes up periodically to receive the TIM of the beacon transmitted from the AP 110. If a bit value of the corresponding STA in the TIM is 0, the corresponding STA sleeps again. If the bit value is 1, the STA should stay awake until a last frame scheduled to be transmitted during a current beacon period is transmitted. The STA can know whether a frame transmitted from the AP 110 is a last frame by checking a MORE DATA field of a frame header. That is, if the MORE DATA field is 0, the frame is a last frame, and accordingly, if there is no frame to be transmitted, the STA may go into a sleep mode after receiving the frame.

However, power consumption of the STA in a PSM mode is determined by an amount of traffic of other STA as well as an amount of traffic to be transmitted to the STA. This is because interruption may occur during data transmission between the AP 110 and the STA when a data transmission attempt is made between the AP 110 and other STA. When an interruption occurs, a period of time over which the STA receives all buffered frames increases, resulting in increased power consumption of the STA. In view of this, a larger number of STAs lead to more power consumption, and accordingly, in a case of a sensor STA to which operation with low power consumption is crucial, a solution is needed.

One of the solutions is to reduce a number of STAs accessing concurrently by differing a channel access time for each STA. In this instance, to designate the time, the AP 110 may divide an interval between beacons or a shorter window period into slots of time unit, and allocate a slot to the STA. This method is referred to as a slot-based channel access scheme in the present invention.

Meanwhile, WLAN such as the Institute of Electrical and Electronics Engineers (IEEE) 802.11z defines tunneled direct link setup (TDLS) between STAs. In the conventional 802.11e, DLS requires the AP 110 to provide support, however although the AP 110 does not provide support, TDLS sends a management action frame necessary for link setup, for example, TDLS Setup Request/Response/Confirm, and TDLS Teardown, through the AP 110 by encapsulating the management action frame into a message of a data frame. To indicate this, Ethertype 89-0d frame of a Logical Link Control (LLC)/Sub-Network Access Protocol (SNAP) header is used. Also, the IEEE 802.11z is characterized by supporting a PSM between TDLS Peer STAs after setting TDLS.

In this instance, in an environment in which in an extremely large number of STAs exist in a network or there is a high probability of collision between STAs due to a hidden node, one of the solutions for resolving the foregoing issue may be a method based on a slot-based channel access scheme in which an AP divides a channel access time into slots having a predetermined length and allots a point in time at which an STA accesses a channel to a slot. A key concept of this method is to reduce a number of STAs accessing concurrently by differing a channel access time for each STA. However, an STA intended to exchange data directly after setting TDLS may use an overlapping slot with a slot allotted previously to another STA by the AP 110. In a case in which the AP 110 allocates a resource based on slots or adjusts a channel access time, the AP 110 needs to know at least a TDLS Peer PSM schedule to effectively use this. Accordingly, the AP 110 according to an embodiment of the present invention may confirm a wakeup schedule (WS) together with the STA1 120 and the STA2 130, in the resource allocation for communication between the STA1 120 and the STA2 130.

Hereinafter, an operation of the AP 110 for allocating a resource based on a slot-based channel access scheme according to an embodiment of the present invention is described.

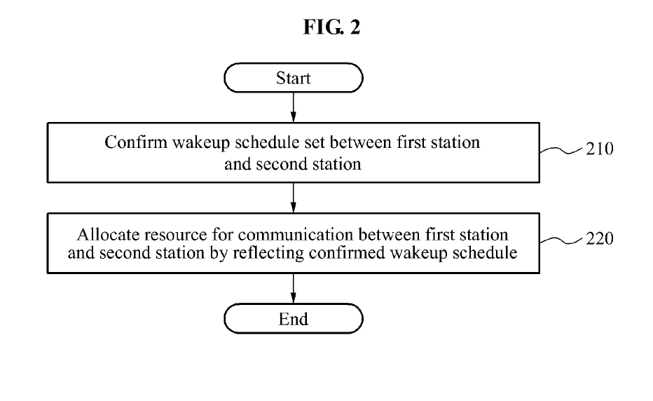

FIG. 2 is a flowchart illustrating a method of allocating a resource in which an AP allocates a resource according to an embodiment of the present invention.

Referring to FIGS. 1 and 2, in a WLAN, the AP 110 may allocate a resource for communication the STA1 120 and the STA2 130 based on a slot-based channel access scheme. In this instance, the resource allocation method of the AP 110 may confirm a WS set between the STA1 120 and the STA2 130 in operation 210.

Also, the resource allocation method may allocate a resource for communication the STA1 120 and the STA2 130 through the slot-based channel access scheme reflecting the confirmed WS.

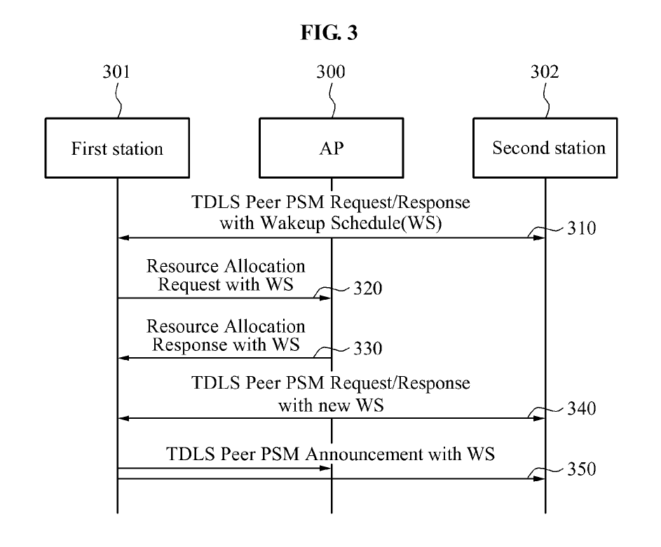

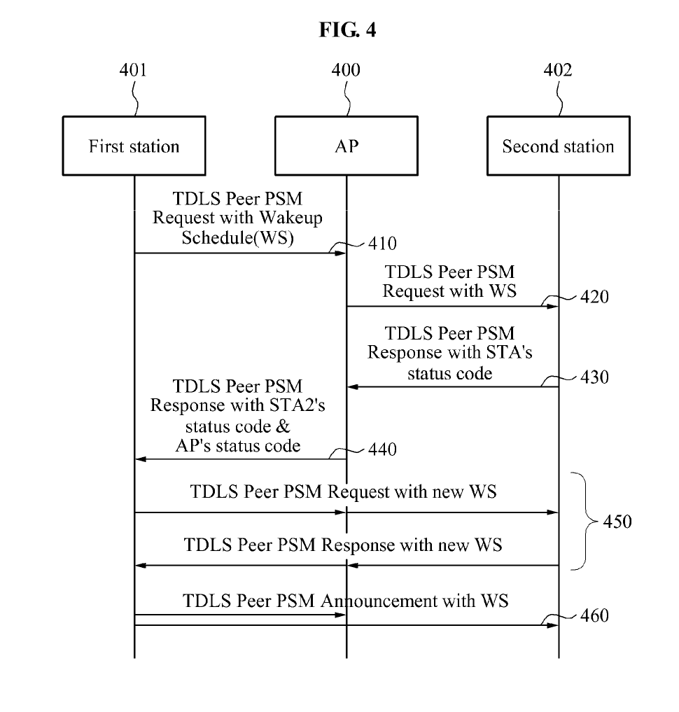

FIGS. 3 and 4 are flowcharts illustrating respective embodiments in which an AP confirms a WS set between a first station and a second station according to an embodiment

The embodiment of FIG. 3 shows that after TDLS Peer STAs set a PSM schedule together, the TDLS Peer STAs notifies an AP of the set PSM schedule, and the embodiment of FIG. 4 shows that setting of an existing TDLS Peer PSM schedule is performed by TDLS Peer STAs and an AP together. Hereinafter, each embodiment is described.

Referring to FIG. 3, a first station 301 and a second station 302 may set a WS in operation 310. More specifically, the first station 301 may transmit a TDLS Peer PSM request frame including a periodic WS to the second station 302. A station transmitting a TDLS Peer PSM request frame such as the first station 301 may be referred to as a TDLS Peer PSM initiator or an initiator. Also, a station receiving a TDLS Peer PSM request frame and transmitting a response frame in response to the request frame such as the second station 302 may be referred to as a TDLS Peer PSM responder or a responder.

When the second station 302 receives the TDLS Peer PSM request frame, the second station 302 may transmit, to the first station 301, a TDLS Peer PSM response frame including a status code indicating acceptance or rejection for the WS. Through this operation, the first station 301 and the second station 302 may set the WS. This process is the same as 802.11z standard.

When the WS between the first station 301 and the second station 302 is set, the first station 301 may transmit a resource allocation request frame including the set WS to an AP 300. That is, the AP 300 may receive the resource allocation request frame including the WS from the first station 301 in operation 320.

The resource allocation request frame may have various formats. According to an embodiment, the resource allocation request frame may include at least one of (i) an indication field indicating the WS, (ii) a field including an identifier for identifying the second station 302—an address or an association ID (AID) for identifying a responder—when a value of the indication field is 1, (iii) a field including a start time representing a wakeup time, (iv) a field including a duration representing a period of time of being awakened, and (v) a field including a cycle of the WS.

The AP 300 may determine whether to accept/reject the WS in operation 330. The AP 300 may transmit, to the first station 301, a resource allocation response frame including a status code indicating acceptance/rejection for the WS.

The first station 301 may receive the resource allocation response frame from the AP 300, and may reflect the status code and confirm the WS. For example, when a value of the status code is 1 implying acceptance for the WS, the first station 301 may confirm the WS transmitted to the AP 300 without any change in the WS.

When the first station 301 reflects the status code and confirms the WS, the first station 301 may transmit, to the AP 300 and the second station 302, a TDLS Peer PSM announcement frame including the confirmed WS. That is, the AP 300 may receive, from the first station 301, the TDLS Peer PSM announcement frame including the WS confirmed by the first station 301 reflecting the status code in operation 350.

According to embodiments, the AP 300 may reject the WS, and may include a recommend WS recommended by the AP 300 in a resource allocation response frame and transmit the resource allocation response frame to the first station 301. That is, in a case of rejection for the WS, the AP 300 may transmit, to the first station 301, the resource allocation response frame including a status code having a value indicating rejection for the WS and a recommend WS.

The first station 301 may generate a new WS reflecting the recommend WS, and may perform the TDLS Peer PSM operation with the second station 302 again in accordance with the generated new WS in operation 340. Through this operation, the first station 301 may confirm the new WS, and may transmit a TDLS Peer PSM announcement frame including the newly confirmed WS to the AP 300. That is, the AP 300 may receive, from the first station 301, the TDLS Peer PSM announcement frame including the WS confirmed by the first station 301 based on the recommend WS.

Referring to FIG. 4, a first station 401 may transmit a TDLS Peer PSM request frame including a WS to an AP 400 in order to confirm the WS. That is, the AP 400 may receive, from the first station 401, the TDLS Peer PSM request frame including the WS in operation 410 (first operation).

The AP 400 may transmit the TDLS Peer PSM request frame to a second station 402 in operation 420 (second operation). According to embodiments, the TDLS Peer PSM request frame transmitted from the first station 401 to the AP 400 may include a link identifier element. Accordingly, the AP 400 may recognize an address of the second station 402 from the link identifier element, and may transmit the TDLS Peer PSM request frame to the second station 402.

When the second station 402 receives the TDLS Peer PSM request frame from the AP 400, the second station 402 may determine whether the second station 402 accepts or rejects the WS. Also, the second station 402 may transmit, to the AP 400, a TDLS Peer PSM response frame including a first status code indicating acceptance/rejection of the second station 402 for the WS in operation 430 (third operation). That is, the AP 400 may receive the TDLS Peer PSM response frame including the first status code from the second station 402.

The AP 400 may determine whether the AP 400 accepts/rejects the WS. Also, the AP 400 may transmit, to the first station 401, the TDLS Peer PSM response frame including a second status code indicating acceptance/rejection of the AP 400 for the WS and the first status code in operation 440 (fourth operation).

The first station 401 may reflect the first status code and the second status code, and may confirm the WS. For example, when both a value of the first status code and a value of the second status code correspond to a value indicating acceptance for the WS, the first station 401 may confirm the WS transmitted to the AP 400 without any change of the WS.

When the first station 401 reflects the first status code and the second status code and confirms the WS, the first station 401 may transmit a TDLS Peer PSM announcement frame including the confirmed WS to the AP 400 and the second station 402. That is, the AP 400 may receive, from the first station 401, the TDLS Peer PSM announcement frame including the WS confirmed by the first station 401 reflecting the first status code and the second status code in operation 460 (fifth operation).

When any one of the first status code and the second status code has a value indicating rejection, PSM schedule setting performed in the first operation through the fourth operation may be considered as a failure, and the first operation through the fourth operation may be performed again in operation 450.

According to embodiments, the AP 400 or the second station 402 may reject the WS and may propose a recommend WS recommended by the AP 400 or the second station 402 to the first station 401. In this instance, the first station 401, the second station 402, and the AP 400 may perform the first operation through the fourth operation iteratively using the recommend WS.

For example, when the AP 400 rejects the WS, the AP 400 may transmit, to the first station 401, the TDLS Peer PSM response frame including (i) the second status code having a value indicating rejection for the WS, (ii) the first status code, and (iii) the recommend WS. As an embodiment of the recommend WS recommended by the AP 400, the AP 400 may allocating, to a cycle of the WS, a longer value among cycles of the two TDLS Peer stations, that is, the first station 401 and the second station 402. Alternatively, the AP 400 may propose a start time of the WS and a duration of the WS to prevent overlapping schedules with a schedule of other access point 400 within a network allocated by the AP 400.

When the first station 401 receives the TDLS Peer PSM response frame, the first station 401 may generate a new WS using the recommend WS recommended by the AP 400, and may transmit the TDLS Peer PSM request frame including the generated WS to the AP 400. That is, the first station 401 may perform the first operation 410 iteratively using the new WS. Similarly, the second operation 420 through the fourth operation 440 may be performed by the first station 401, the second station 402, and the AP 400 using the new WS.

Meanwhile, the frame transmitted and received at each operation in the second cycle may be of a public management action frame type.

As described through FIGS. 3 and 4 above, the resource allocation method of the AP according to an embodiment may enable negotiation for the TDLS Peer PSM schedule between the stations and the AP. Meanwhile, according to embodiments, when the second station, that is, the responder accepts the WS but the AP rejects the WS, the first station, that is, the initiator may set the PSM schedule. In this instance, the first station may transmit the TDLS Peer PSM announcement frame to the AP and the second station. However, a collision probability may be increased when compared to a contrary case because the AP does not protect the schedule.

However, when the AP accepts the PSM schedule, this schedule period may be protected. This may be enabled by setting a beacon transmitted from the AP to be allocated to any one of the first station and the second station. This may be found through a method of allocating a slot to a station in a slot-based channel access. In this instance, indication that the additionally allocated slot is for TDLS but not for downlink (DL)/uplink (UL) with the AP may be provided. If the channel access of the first station and the second station is limited and the WS period of the PSM schedule is included in a period allocated to other station in a nested form, indication that only the slot corresponding to the WS period is exceptional may be provided. A reserved AID to the station group for this purpose may be used, or other indication bit may be used.

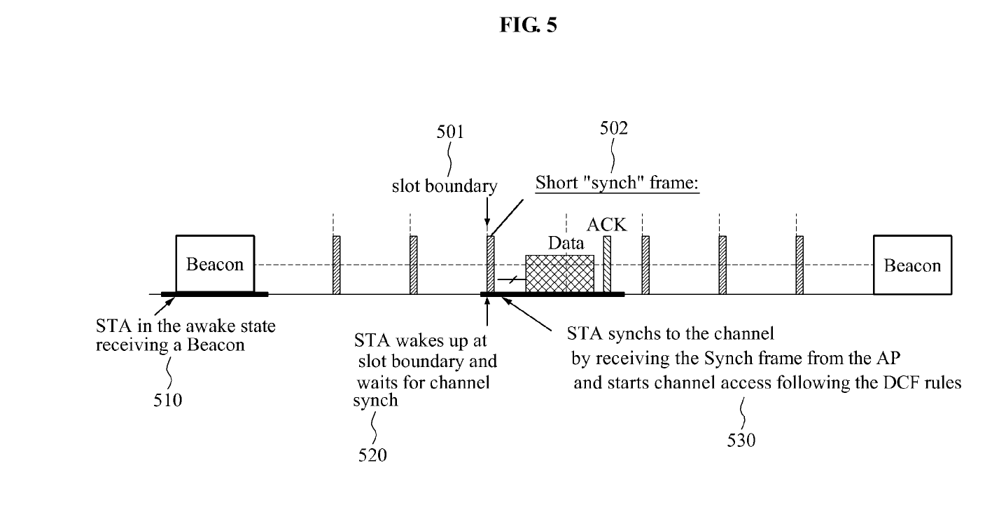

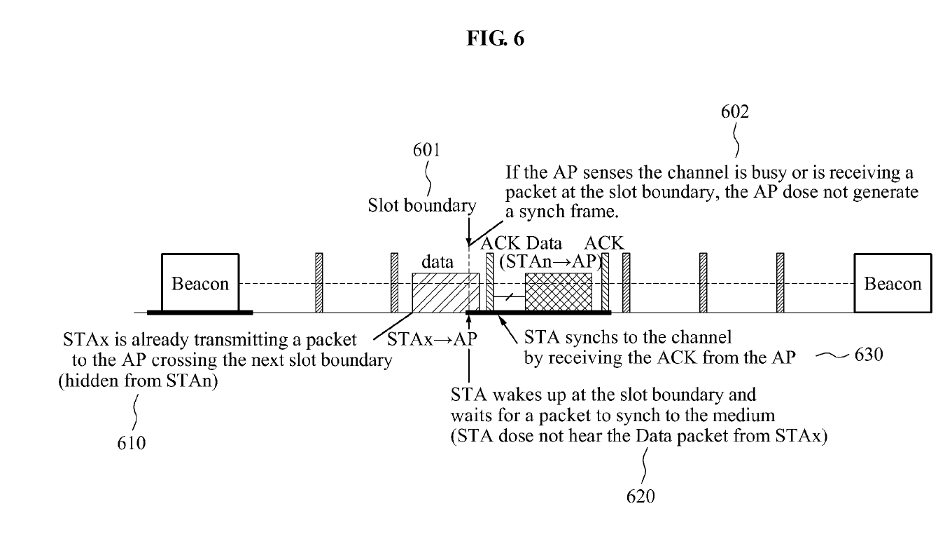

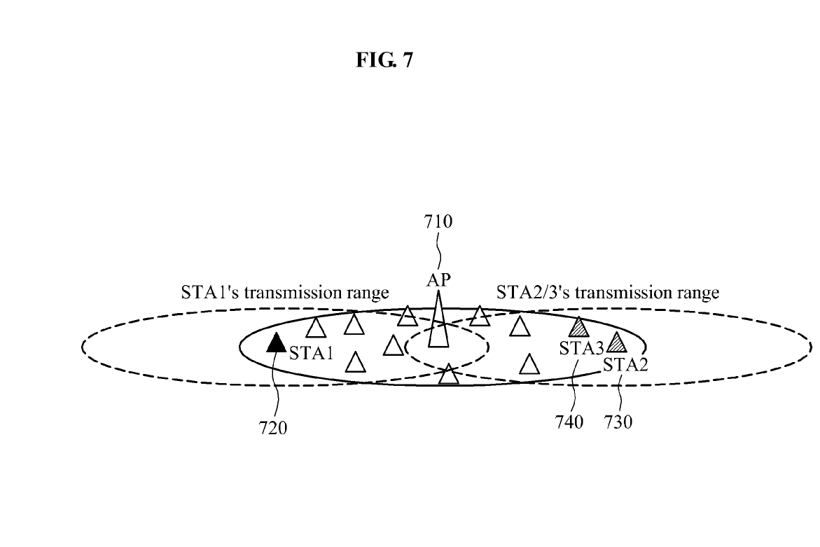

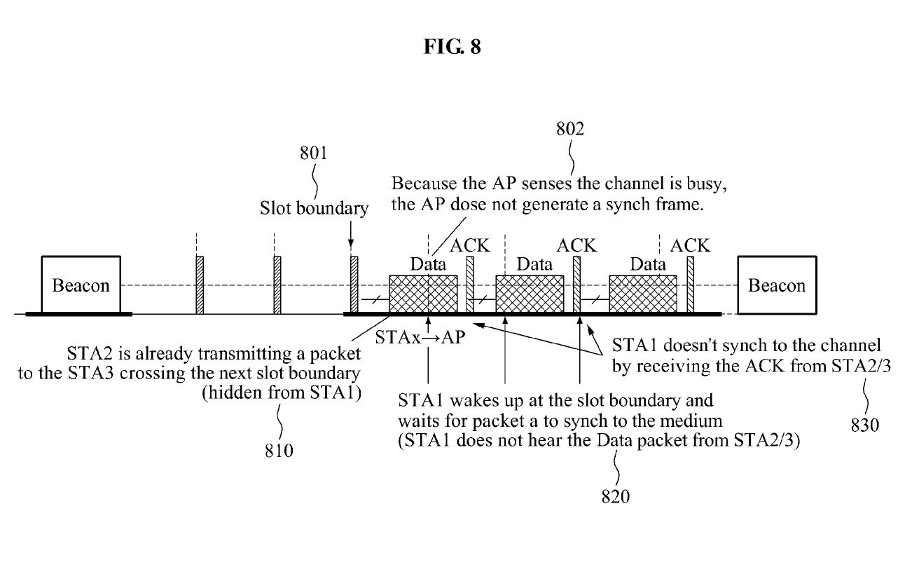

When the WS is confirmed as described in the foregoing, the method of allocating a resource in which the AP allocates a resource may allocate a resource for communication between the first station and the second station through the slot-based channel access scheme reflecting the confirmed WS. A further description is provided with reference to FIGS. 7 and 8, and prior to the description, a conventional slot-based channel access scheme is described with reference to FIGS. 5 and 6 for the purpose of assisting the understanding of the present invention.

FIGS. 5 and 6 are diagrams illustrating an example of using a synch frame to prevent collision or save power when two stations waking up from sleep are hidden nodes from each other in a conventional slot-based channel access scheme.

A station that is allocated a slot from an AP and wakes up at the slot start does not know whether there is a hidden node. To help this, the AP may transmit a synch frame if a channel is in an idle state at the slot start.

Referring to FIG. 5, in a conventional slot-based channel access scheme, a station may receive a synch frame from an AP at a slot boundary, and may access a channel under enhanced distributed channel access (EDCA) immediately after receiving the synch frame. More specifically, when the station is in an awake state, the station may receive a beacon message from the AP in operation 510. Also, the station may wake up at a slot boundary 501 and wait for channel synchronization in operation 520. In this instance, the AP may transmit the synch frame 502 to the station at the slot boundary 501. Accordingly, the station may synchronize to the channel using the synch frame 502 received from the AP, and start channel access according to a distributed coordination function (DCF) rule in operation 530.

As another conventional operational example, referring to FIG. 6, when a channel is determined to be busy or data is being received from a station at a slot boundary 601, an AP may not transmit a synch frame in operation 602. The AP may not access a channel but await, and the waiting may maintain until any one is satisfied among (i) reception of a synch frame, (ii) reception of another frame from the AP, and (iii) end of a probe delay period (a waiting rule of the station). More specifically, when a station x STA x is a hidden node from a station n STA n, the STA x may transmit a packet to the AP across the slot boundary 601 in operation 610. In this instance, the station may wake up at the slot boundary 601 and wait for a packet to synchronize to a medium in operation 620. In this instance, the station may hear a data packet from the STA x. Also, the station may synchronize a channel when the station receives an acknowledgement (ACK) message from the AP.

The ‘conventional synch frame method for resolving the hidden node in the slot-based channel access scheme’ as described in FIGS. 5 and 6 causes a problem when applied to a hidden node problem at the time of direct data exchange.

FIGS. 7 and 8 illustrate a network environment under an assumption that direct data exchange is enabled by an AP 710 allocating a resource to an STA2 730 and an STA3 740 and transmitting a synch frame, and an initiator, for example, the STA2 accessing a channel. Also, in this instance, a station 1 STA1 720 may be hidden from both the STA2 730 and the STA3 740.

For example, the STA2 730 may transmit a packet to the STA3 740 across a next slot boundary 801. However, the AP may determine that the channel is busy and may not transmit the synch frame in operation 802. In this case, because the STA1 720 does not receive the synch frame and other frame as well, the STA1 may perform channel access under EDCA after a probe delay, and because the channel is in an idle state, the STA1 720 may transmit data to the AP, which may cause a collision at the AP. For example, the STA1 may wake up at the slot boundary and wait for a packet for synchronization to a medium in operation 820. In this instance, the STA1 720 may not hear a data packet from the STA2 730 and the STA3 740. Also, the STA1 720 may not receive an ACK from the STA2 730 and the STA3 740 and synchronize to a channel in operation 830.

Accordingly, a method for resolving this issue is needed, and hereinafter, embodiments of the present invention describe the method for resolving the issue as described in FIGS. 5 through 8.

According to an embodiment of the present invention, to resolve the foregoing issue, in the resource allocation, the AP may allocate a resource for communication between the first station and the second station through the slot-based channel access scheme having the waiting rule that enables the station to await continuously until the AP receives a synch frame or other frame although a probe delay period elapses.

That is, the method of allocating a resource according to an embodiment may resolve the foregoing issue by modifying the waiting rule of the station described in FIG. 6. Under the waiting rule according to an embodiment, the station may not receive a synch frame and other frame as well, and although a probe delay elapses, may maintain a waiting state. Because the AP does not transmit data during direct data exchange, a station hidden from the TDLS Peer STAs in the network may consider a channel as being in an idle state after a probe delay and make a transmission attempt to the AP, which may cause a collision, and this should be prevented. This phenomenon may occur in an overlapping basic service set (OBSS) in which when a signal transmitted from a neighboring basic service set (BSS) arrives at an AP, a channel is determined to be busy and a station out of this range cannot hear. In this case, although the channel is in an idle state after a probe delay, the station may await continuously until a signal from the AP arrives.

According to another embodiment, in the resource allocation, the AP may allocate a resource for communication between the first station and the second station through the slot-based channel access scheme that allows transmission of a frame notifying that a channel is busy at a preset cycle. That is, if a synch frame is for notifying that a channel is in an idle state, with respect to a frame having an opposite function—a frame notifying that a channel is busy—being defined and transmitted, a station receiving the frame may consider a channel as being busy and transit to a sleep state or await until the channel goes into an idle state.

The frame notifying that the channel is busy may be transmitted by setting an initiator STA as a receiving address or resource allocation may be announced to an initiator by setting an AID, thereby preventing an access of other STA. Also, a network allocation vector (NAV) may be set in the frame notifying that the channel is busy, so that the channel may be protected during a period set by the NAV. A cycle of sending the frame notifying that the channel is busy may be preset by the AP and the initiator. When a preset cycle comes in the middle of data exchange with a responder, the initiator may hand over the channel to the AP to transmit the frame notifying that the channel is busy.

According to another embodiment, the resource allocation method for allocating a resource in the AP may indicate, in a beacon, that a slot corresponding to a period of the confirmed WS is allocated to at least one of the first station and the second station, and may transmit the indicated beacon.

According to an aspect of the present invention, when the station wakes up in accordance with the TDLS Peer PSM schedule and performs data exchange, in a case in which the data exchange is completed earlier than a predetermined period of the WS and thus there is no more data to transmit, the initiator may notify the end of the PSM by transmitting a control frame (CF)-End frame to the AP. That is, the AP may receive, from the first station, the CF-End frame indicating that data exchange between the first station and the second station is completed. Also, the AP may broadcast the received CF-End frame to allow other station to use the channel.

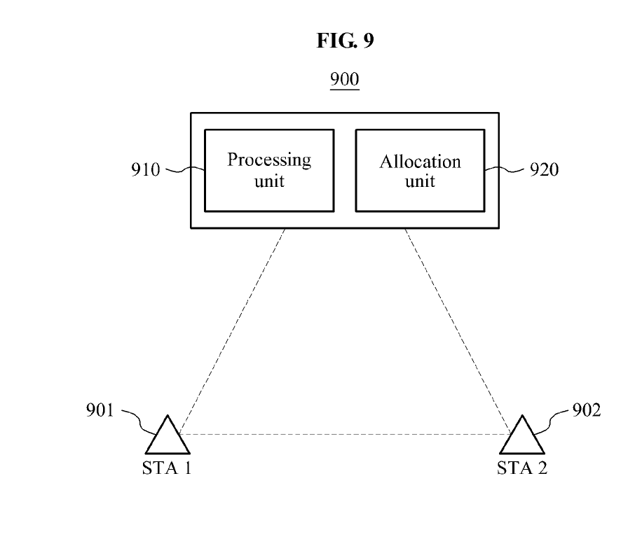

FIG. 9 is a diagram illustrating a configuration of an apparatus 900 for allocating a resource according to an embodiment.

Referring to FIG. 9, the apparatus 900 for allocating a resource may allocate a resource for communication between a first station 901 and a second station 902 based on a slot-based channel access scheme in a WLAN. The apparatus 900 for allocating a resource according to an embodiment may operate as a module that is inserted into an AP.

The apparatus 900 for allocating a resource may include a processing unit 910 and an allocation unit 920.

The processing unit 910 may confirm a WS set between the first station 901 and the second station 902

The allocation unit 920 may allocate a resource for communication between the first station 901 and the second station 902 through the slot-based channel access scheme reflecting the confirmed WS.

The processing unit 910 according to an embodiment may confirm the WS set between the first station 901 and the second station 902, by performing the operation described in FIGS. 3 and 4.

More specifically, the processing unit 910 according to an embodiment may receive a resource allocation request frame including the WS from the first station 901. Also, the processing unit 910 may transmit a resource allocation response frame including a status code indicating acceptance/rejection for the WS to the first station 901. Also, the processing unit 910 may receive, from the first station 901, a TDLS Peer PSM announcement frame confirmed by the first station 901 including the WS reflecting the status code.

According to another embodiment, the processing unit 910 may receive a TDLS Peer PSM request frame including the WS from the first station 901. Also, the processing unit 910 may transmit the TDLS Peer PSM request frame to the second station 902. Also, the processing unit 910 may receive, from the second station 902, a TDLS Peer PSM response frame including a first status code indicating acceptance/rejection of the second station 902 for the WS. The processing unit 910 may transmit, to the first station 901, the TDLS Peer PSM response frame including a second status code indicating acceptance/rejection of an AP for the WS and the first status code. The processing unit 910 may receive, from the first station 901, a TDLS Peer PSM announcement frame including the WS confirmed by the first station 901 reflecting the first status code and the second status code.

The embodiment of the operation of confirming the WS in the processing unit 910 is described in FIGS. 3 and 4 above, and thus a further detailed description is omitted herein.

According to embodiments, the allocation unit 920 may indicate, in a beacon, that a slot corresponding to a period of the confirmed WS is allocated to at least one of the first station 901 and the second station 902, and may transmit the indicated beacon.

According to another embodiment, the allocation unit 920 may allocate a resource for communication between the first station 901 and the second station 902 through a slot-based channel access scheme having a waiting rule that that enables the station to await continuously until reception of a synch frame or other frame although a probe delay period elapses.

According to another embodiment, the allocation unit 920 may allocate a resource for communication between the first station 901 and the second station 902 through a slot-based channel access scheme that allows transmission of a frame notifying that a channel is busy at a preset cycle.

The embodiment of the operation of allocating a resource in the allocation unit 920 is described in FIGS. 5 through 8 above, and thus a further detailed description is omitted herein.

According to embodiments, the processing unit 910 may receive, from the first station 901, a CF-End frame indicating that data exchange between the first station 901 and the second station 902 is completed. Also, the processing unit 910 may broadcast the received CF-End frame.

The embodiments according to the present invention may be recorded, stored, or fixed in one or more non-transitory computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media such as hard discs, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa. In addition, a non-transitory computer-readable storage medium may be distributed among computer systems connected through a network and non-transitory computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A method of allocating a resource in which an access point allocates a resource for communication between a first station and a second station based on a slot-based channel access scheme in a wireless local area network, the method comprising:
confirming a wakeup schedule (WS) set between the first station and the second station; and
allocating the resource for communication between the first station and the second station through the slot-based channel access scheme reflecting the confirmed WS.

2. The method of claim 1, wherein the confirming of the WS comprises:
receiving a resource allocation request frame including the WS from the first station;
transmitting a resource allocation response frame including a status code indicating acceptance/rejection for the WS to the first station; and
receiving, from the first station, a tunneled direct link setup (TDLS) Peer power saving mode (PSM) announcement frame including the WS confirmed by the first station reflecting the status code.

3. The method of claim 2, wherein the resource allocation request frame includes at least one of an indication field indicating the WS, a field including an identifier for identifying the second station when a value of the indication field is 1, a field including a start time representing a wakeup time, a field including a duration representing a period of time of being awakened, and a field including a cycle of the WS.

4. The method of claim 2, wherein the transmitting of the resource allocation response frame comprises transmitting, to the first station, the resource allocation response frame including a status code having a value indicating rejection for the WS and a recommend WS, in a case of rejection for the WS, and
the receiving of the TDLS Peer PSM announcement frame comprises receiving, from the first station, the TDLS Peer PSM announcement frame including the WS confirmed by the first station based on the recommend WS.

5. The method of claim 1, wherein the confirming of the WS comprises:
a first operation of receiving a TDLS Peer PSM request frame including the WS from the first station;
a second operation of transmitting the TDLS Peer PSM request frame to the second station;
a third operation of receiving, from the second station, a TDLS Peer PSM response frame including a first status code indicating whether the second station accepts/rejects the WS;
a fourth operation of transmitting, to the first station, the TDLS Peer PSM response frame including a second status code indicating whether the access point accepts/rejects the WS and the first status code; and
a fifth operation of receiving, from the first station, the TDLS Peer PSM announcement frame including the WS confirmed by the first station reflecting the first status code and the second status code.

6. The method of claim 5, wherein the TDLS Peer PSM request frame received from the first station includes a link identifier element, and
the second operation comprises transmitting the TDLS Peer PSM request frame to the second station using the link identifier element.

7. The method of claim 5, wherein the fourth operation comprises transmitting, to the first station, the TDLS Peer PSM response frame including the second status code having a value indicating rejection for the WS, the first status code, and the recommend WS, in a case of rejection for the WS, and
the method further comprises:
a sixth operation of performing the first operation through the fourth operation iteratively using the recommend WS.

8. The method of claim 7, wherein the frame transmitted/received at each operation performed iteratively in the sixth operation is of a public management action frame type.

9. The method of claim 1, further comprising:
indicating, in a beacon, that a slot corresponding to a period of the confirmed WS is allocated to at least one of the first station and the second station, and transmitting the indicated beacon.

10. The method of claim 1, wherein the allocating of the resource comprises allocating the resource for communication between the first station and the second station through the slot-based channel access scheme having a waiting rule that that enables the station to await continuously until reception of a synch frame or other frame, although a probe delay period elapses.

11. The method of claim 1, further comprising:
receiving, from the first station, a control frame (CF)-End frame indicating that data exchange between the first station and the second station is completed; and
broadcasting the received CF-End frame.

12. A resource allocation apparatus for allocating a resource for communication between a first station and a second station based on a slot-based channel access scheme in a wireless local area network, the apparatus comprising:
a processing unit to confirm a wakeup schedule (WS) set between the first station and the second station; and
an allocation unit to allocate the resource for communication between the first station and the second station through the slot-based channel access scheme reflecting the confirmed WS.

13. The apparatus of claim 12, wherein the processing unit is operative to:
receive a resource allocation request frame including the WS from the first station,
transmit a resource allocation response frame including a status code indicating acceptance/rejection for the WS to the first station, and
receive, from the first station, a tunneled direct link setup (TDLS) Peer power saving mode (PSM) announcement frame including the WS confirmed by the first station reflecting the status code.

14. The apparatus of claim 12, wherein the processing unit is operative to:
receive a TDLS Peer PSM request frame including the WS from the first station,
transmit the TDLS Peer PSM request frame to the second station,
receive, from the second station, a TDLS Peer PSM response frame including a first status code indicating whether the second station accepts/rejects the WS,
transmit, to the first station, the TDLS Peer PSM response frame including a second status code indicating whether the access point accepts/rejects the WS and the first status code, and
receive, from the first station, the TDLS Peer PSM announcement frame including the WS confirmed by the first station reflecting the first status code and the second status code.
